(19) United States
(12) Patent Application Publication
(10) Pub. No.: US 2026/0348400 A1
(43) Pub. Date: Nov. 5, 2026

(54) EDDY CURRENT DAMPER AND VACUUM PUMP

(71) Applicant: Leybold GmbH, Cologne (DE)

(72) Inventors: Christian Hoesgen, Cologne (DE); Dirk Christian Kalisch, Cologne (DE); Alois Greven, Cologne (DE); Daniel Radermacher, Cologne (DE); Christian Berger, Cologne (DE); Roman Dembek, Cologne (DE); Gerald Jungmayr, Linz (AT); Robert Santner, Linz (AT)

(21) Appl. No.: 19/101,461

(22) PCT Filed: Aug. 7, 2023
(86) PCT No.: PCT/EP2023/071835

§ 371 Date: Feb. 5, 2025

(30) Foreign Application Priority Data
Aug. 9, 2022 (GB) 2211561.2

(51) Int. Cl. F04D 29/66; F04D 19/04; F04D 29/058; F16F 15/03

(52) U.S. Cl. CPC F04D 29/668; F04D 19/042; F04D 19/048; F04D 29/058; F16F 15/035

(57) ABSTRACT

Eddy current damper for a vacuum pump comprising a conductive ring connectable to a housing; a magnetic element connectable to a rotor shaft to be rotated relative to the conductive ring. Therein the conductive ring is made from a conductive material and comprises an axial extending part and a radial extending part. Further, the magnetic element comprises at least one ring magnet wherein the radial extending part of the conductive ring is arranged axially next to the at least one ring magnet.

### CROSS-REFERENCE OF RELATED APPLICATION

This application is a Section 371 National Stage Application of Inter-national Application No. PCT/EP2023/071835, filed Aug. 7, 2023, which is incorporated by reference in its entirety and published as WO 2024/033312 A1 on Feb. 15, 2024, the content of which is hereby incorporated by reference in its entirety and which claims priority of British Application No. GB2211561.2, filed Aug. 9, 2022.

### FIELD

The present invention relates to an eddy current damper for a vacuum pump, in particular for a turbomolecular vacuum pump. Further, the present invention relates to a vacuum pump including such an eddy current damper.

### BACKGROUND

Common vacuum pumps include a housing having an inlet and an outlet. A rotor is disposed in the housing and rotatably supported by at least one bearing. The rotor includes a rotor shaft and at least a pump element. When rotated by an electromotor, by the pump element a gaseous medium is conveyed from the inlet towards the outlet.

It is known to use magnetic bearings which are friction free in order to support the rotor. However, in particular when using magnetic bearings, it is important to avoid radial vibrations of the rotor caused for example by imbalances of the rotor or by imprecisions of the magnetic bearings.

It is known to use eddy current damper to reduce the radial vibrations of the rotor. Eddy current dampers comprise a magnetic element connected to and rotated with the rotor and at least one conductive element which is not rotated and connected to the housing. By the radial vibrations, an eddy current is induced in the conductive element which creates a magnetic force acting in the opposite direction of the vibration movements resulting in a restoring force to the rotor, thereby damping the radial vibrations of the rotor. However, common eddy current dampers are bulky and due to the additional element of the eddy current damper space requirements might not be met increasing the overall size of the vacuum pump.

The discussion above is merely provided for general background information and is not intended to be used as an aid in determining the scope of the claimed subject matter. The claimed subject matter is not limited to implementations that solve any or all disadvantages noted in the background.

### SUMMARY

The problem is solved by an eddy current damper according to claim 1 and a vacuum pump according to claim 20.

The eddy current damper (EDC) for a vacuum pump according to the present invention comprises a conductive ring being static and connectable to a housing of the vacuum pump. Therein, the conductive ring is made from a conductive material such as copper, aluminum or the like. The conductive ring further comprises an axial extending part and a radial extending part, preferably integrally built as one piece. Thus, a cross-section of the conductive ring might be L-shaped or T-shaped. Thus, the axial extending part and the radial extending part can be connected with each other at their respective ends in order to form a L-shaped cross-section. Alternatively, the radial extending part can be connected to the axial extending part by connecting the end of the radial extending part to a position between the two ends of the axial extending part to form a T-shaped cross-section.

According to the invention, the ECD further comprises a magnetic element having at least one ring magnet preferably built as permanent magnet. The magnetic element is connectable to a rotor shaft of the vacuum pump to be rotated relative to the conductive ring. Therein, the radial extending part of the conductive ring is arranged axial next to the at least one ring magnet. Thus, the magnetic field of the at least one ring magnet induces eddy currents into the radial extending part of the conductive ring. At the same time, the axial extending part of the conductive ring serves as conductor in order to allow efficient flow of the eddy current within the conductive ring in order to efficiently create the magnetic field by the eddy current. Thus, by the axial extending part of the conductive ring, the ohmic resistance of the conductive ring is reduced in order to reduce attenuation of the eddy currents within the conductive ring. Thus, by the specific shape of the conductive ring, a compact and efficient design can be provided allowing reliable and efficient damping of radial vibrations of the rotor of the vacuum pump.

Preferably, the magnetic element comprises a second ring magnet arranged opposite to the first ring magnet relative to the conductive ring. Thus, the magnetic field applied to the radial extending part of the conducting ring is enhanced by the second ring magnet. In particular, if a second ring magnet is included to the magnetic element, the cross-section of the conductive ring is preferably T-shaped.

Preferably, the first ring magnet and the second ring magnet have the same orientation of the magnetic pole in order to enhance the magnetic field at the position of the radial extending part of the conductive ring.

Preferably, the second ring magnet is connectable to the housing and thus, static and not rotated. Alternatively, the second ring magnet is also connectable to the rotor shaft such as the first ring magnet and rotated relatively to the conductive ring.

Preferably, by the first ring magnet and the second ring magnet, a radial extending gap is formed, wherein the radial extending part of the conductive ring is at least partially extending into the gap. Thus, the first ring magnet and the second ring magnet are arranged directly next to the radial extending part of the conductive ring along the axial direction. By creating a gap between the first ring magnet and the second ring magnet, the magnetic field at the position of the radial extending part of the conductive ring is enhanced and thereby efficiently inducing eddy currents into the conductive ring.

Preferably, a yoke is provided made from a magnetic material magnetically connecting the first ring magnet and the second ring magnet in order to create a magnetic circuit and further enhance the magnetic field at the position of the radial extending part of the conductive ring.

Preferably, the yoke comprises two radial extending parts each magnetically connected to the first ring magnet and second ring magnet and an axial extending part connecting the two radial extending parts of the yoke. Thus, the yoke is substantially U-shaped.

Preferably, the yoke is connected to the rotor shaft and rotated together with the first ring magnet and second ring magnet. Consequently, the yoke and in particular the two radial extending parts of the yoke are directly attached to the first ring magnet and the second ring magnet.

Alternatively, the yoke is static and connected with the housing. Consequently, the yoke and in particular the two radial extending parts of the yoke are not directly attached to the first ring magnet and the second ring magnet and the magnetic field is permeating across a gap between the static yoke and the rotating ring magnets in order to create the magnetic circuit.

Preferably, the radial width of the axial extending part of the yoke is smaller than the axial width of the first ring magnet. Alternatively or additionally, the radial width of the axial extending part of the yoke is smaller than the axial width of the second ring magnet. Therein, it was surprisingly found to be beneficial to the damping efficiency if the radial width of the axial extending part of the yoke is smaller than the axial width of the first ring magnet and/or the radial width of the axial extending part of the yoke is smaller than the axial width of the second ring magnet.

Preferably, the axial width of at least one and preferably of the two radial extending parts of the yoke is smaller than the axial width of the first ring magnet. Alternatively or additionally, the axial width of at least one of the two radial extending parts and preferably of both radial extending parts of the yoke are smaller than the axial width of the second ring magnet. Therein, it was surprisingly found to be beneficial to the damping efficiency if the axial width of at least one and preferably of the two radial extending parts of the yoke is smaller than the axial width of the first ring magnet and/or the axial width of at least one of the two radial extending parts and preferably of both radial extending parts of the yoke are smaller than the axial width of the second ring magnet.

Preferably, the radial distance between the radial outermost surface of the axial extending part of the yoke to the first ring magnet is between 1 time to 5 times the axial width of the first ring magnet. Alternatively or additionally, the distance between the radial outermost surface of the axial extending part of the yoke to the second ring magnet is between 1 time to 5 times the axial width of the second ring magnet. Therein, it was surprisingly found to be beneficial to the damping efficiency if the radial distance between the radial outermost surface of the axial extending part of the yoke to the first ring magnet and/or second ring magnet is between 1 time to 5 times the axial width of the first ring magnet and/or second ring magnet.

Preferably, the first ring magnet extends in the axial direction beyond the axial extending element of the conductive ring. Alternatively or additionally, the second ring magnet extends in the axial direction beyond the axial extending element of the conductive ring. Thus, it was surprisingly found to be beneficial to the damping efficiency if the axial extending element of the conductive ring is partially surrounding the first and/or second ring magnets in a radial direction.

Preferably, the conductive ring comprises a second axial extending part arranged at the opposite end of the radial extending part, opposite to the first axial extending part. Thus, the cross-section of the conductive ring is substantially H-shaped or U-shaped, wherein the first ring magnet is arranged in the trough of the U- or H-shaped cross-section. In particular, if a second ring magnet is included, the conductive ring has a H-shaped cross-section, wherein the second ring magnet is arranged in the second trough of the H-shaped cross-section of the conductive ring. By the second axial extending element of the conductive ring conductance of the conductive ring is further enhanced by increasing the cross-section of the conductive ring, thereby reducing the ohmic resistance of the conductive ring and allowing efficient flow of the eddy currents within the conductive ring.

Preferably, the conductive ring is separated into two-parts along a circumferential direction of the conductive ring. Thus, the conductive ring can be easily assembled around the rotor shaft and around the first ring magnet and preferably the second ring magnet in an interlocking manner nested with each other. Since the field lines of the magnetic field are arranged in an axial direction and also the intersection of the parts of the conductive ring is in an axial direction, separation of the conductive ring into two or more parts has no or only little influence on the magnetic field. Preferably, a conductive enhancing material can be placed in the intersection such as a conductive paste or the like.

Preferably, the conductive ring and the magnetic element are rotationally symmetrical.

Preferably, a distance between the outermost radial surface of the conductive ring and the respective outermost radial surface of the first ring magnet is smaller than the radial width of the first ring magnet and/or smaller than the radial width of the second ring magnet. Alternatively or additionally, the distance between the innermost radial surface of the conductive ring and the respective innermost radial surface of the second ring magnet is smaller than the radial width of the first ring magnet or the radial width of the second ring magnet. Therein, it was surprisingly found to be beneficial to the damping efficiency if the distance between the outermost/innermost radial surface of the conductive ring and the respective outermost/innermost radial surface of the first ring magnet is smaller than the radial width of the first ring magnet and/or smaller than the radial width of the second ring magnet.

Preferably, the axial width of the radial extending part of the conductive ring is smaller than the axial width of the first ring magnet and/or smaller than the axial width of the second ring magnet. Therein, it was surprisingly found to be beneficial to the damping efficiency if the axial width of the radial extending part of the conductive ring is smaller than the axial width of the first ring magnet and/or smaller than the axial width of the second ring magnet.

Preferably, the radial width of the first ring magnet is between 2 mm and 20 mm and more preferably between 3 mm and 10 mm. Alternatively or additionally, the radial width of the second ring magnet it between 2 mm and 20 mm and more preferably between 3 mm and 10 mm. Therein, it was surprisingly found to be beneficial to the damping efficiency while maintaining the space requirements if the radial width of the first ring magnet is between 2 mm and 20 mm and more preferably between 3 mm and 10 mm

Preferably, the axial distance between the radial extending part of the conductive ring and the first ring magnet is between 0.05 mm and 2 mm and more preferably between 0.1 mm and 1 mm. Alternatively or additionally, the axial distance between the radial extending part of the conductive ring and the second ring magnet is between 0.05 mm and 2 mm and more preferably between 0.1 mm and 1 mm. Therein, it was surprisingly found to be beneficial to the damping efficiency while maintaining the space requirements if the axial distance between the radial extending part of the conductive ring and the first ring magnet and/or second ring magnet is between 0.05 mm and 2 mm and more preferably between 0.1 mm and 1 mm.

Preferably, the radial distance between an inner surface of the first axial extending part of the conductive ring and the first ring magnet and/or second ring magnet is between 0.05 mm and 2 mm and more preferably between 0.1 mm and 1 mm. Therein, it was surprisingly found to be beneficial to the damping efficiency while maintaining the space requirements if the radial distance between an inner surface of the first axial extending part of the conductive ring and the first ring magnet/second ring magnet, respectively, is between 0.05 mm and 2 mm and more preferably between 0.1 mm and 1 mm.

Preferably, a radial distance between an outer surface of the second axial extending part of the conductive ring and the first ring magnet and/or the second ring magnet is between 0.05 mm and 2 mm and more preferably between 0.1 mm and 1 mm. Therein, it was surprisingly found to be beneficial to the damping efficiency while maintaining the space requirements if the radial distance between an outer surface of the second axial extending part of the conductive ring and the first ring magnet/second ring magnet, respectively, is between 0.05 mm and 2 mm and more preferably between 0.1 mm and 1 mm.

Preferably, the eddy current damper comprises at least one second conductive ring connectable to the housing and at least one corresponding second magnetic element connectable to the rotor shaft to be rotated relative to the conductive ring. Thus, the eddy current damper comprises a stacked arrangement along the axial direction of the rotor shaft comprising more than one conductive ring and a corresponding number of magnetic elements. Therein, the at least one second conductive ring and the at least one second magnetic ring are built along the features described above with respect to the conductive ring and the respective magnetic elements. Therein, the conductive rings with their corresponding magnetic elements are built identically or might be built differently.

Preferably, the ring magnet of one conductive ring is at the same time the ring magnet of the second conductive ring. Thus, one ring magnet serves simultaneously as magnetic element to induce eddy currents into two conductive rings arranged directly next to each other in a stacked or alternating manner.

In a further aspect of the present invention, a vacuum pump is provided comprising a housing, a rotor disposed in the housing and an eddy current damper as described before. Therein, the first ring magnet is connected to the rotor and rotated together with the rotor, wherein the conductive ring is connected to the housing.

Preferably, the vacuum pump is built along the features as described before in connection with the eddy current damper.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

In the following, the invention is described in more detail with reference to accompanying figures.

Figures show:

FIG. 1 a vacuum pump according to the present invention,

FIG. 2 a first embodiment of the eddy current damper according to the present invention,

FIG. 3 a second embodiment of the eddy current damper according to the present invention,

FIG. 4 a detailed view of the conductive ring according to the present invention and

FIG. 5a detailed view of the magnetic element according to the present invention.

### DETAILED DESCRIPTION

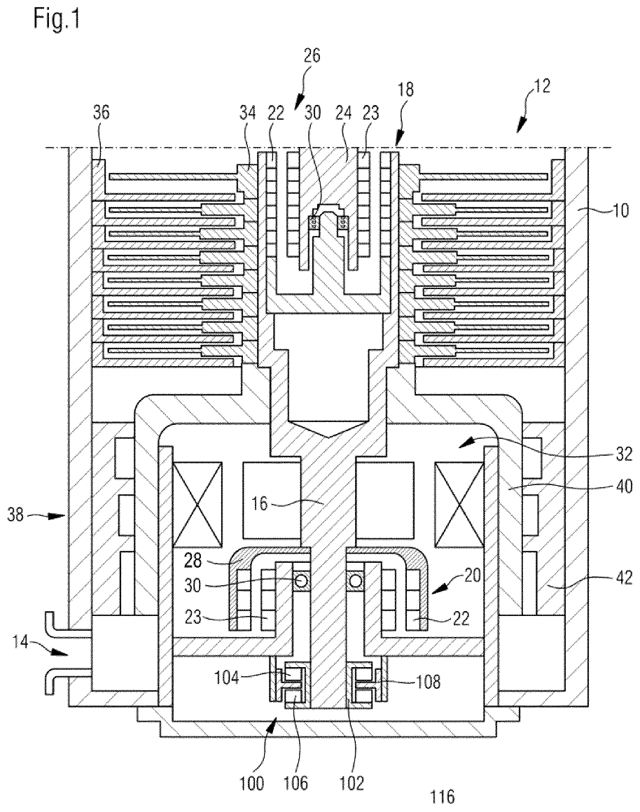

Referring to FIG. 1 showing a vacuum pump built as turbomolecular pump. The vacuum pump comprises a housing 10 including an inlet 12 and an outlet 14. A rotor 16 is disposed in the housing and supported by a first radial bearing 18 built as permanent magnetic bearing, and a second radial bearing 20 also built as permanent magnetic bearing. The first radial bearing 18 and the second radial bearing 20 comprise a plurality of magnet rings 22, 23. Therein the static magnet rings 23 of the first radial bearing 18 are attached to a trunnion 24 extending into a recess 26 of the rotor shaft 16. The rotated magnet rings 22 are arranged at the inner surface of the recess radially next to the static magnet rings 23. For the second radial bearing 20 the rotated magnet rings 22 are attached inside a bell-shaped element 28 radially next to the static magnet rings 23 connected to the housing. Therein, the static magnet rings 23 of the first radial bearing 18 and the second radial bearing 20 are in mutual repulsion to each of the rotated magnet rings 22 of the first radial bearing 18 and the second radial bearing 20, respectively, thereby providing a rotatably support of the rotor 16 within the housing 10

Further, the first radial bearing 18 and the second radial bearing 20 comprise emergency running bearings 30 built as ball bearings. The rotor shaft 16 is driven by electromotor 32. Attached to the rotor shaft 16 are a plurality of pump elements 34 built as vanes interacting with stator elements 36 connected to the housing 10 of the vacuum pump and arranged alternating with the pump elements 34. In addition, the vacuum pump of FIG. 1 comprises a Holweck stage 38 comprising a rotating cylinder 40 interacting with a threated stator 42 connected to the housing. By rotating of the rotor shaft 16 a gaseous medium is conveyed from the inlet 12 of the vacuum pump towards the outlet 14.

Further, the vacuum pump shown in FIG. 1 comprises an eddy current damper (ECD) 100. The ECD 100 comprises a first ring magnet 104 and a second ring magnet 106 which are connected by a magnetic yoke 102 in order to create a magnetic circuit. By the first ring magnet 104 and the second ring magnet 106 a gap 105 is created. The ECD 100 further comprises a conductive ring 108 comprising an axial extending part 110A and a radial extending part 112. Therein, the radial extending part 112 extends into the gap 105 between the first ring magnet 104 and the second ring magnet 106. Therein, the first ring magnet is connected to the rotor shaft 16 and rotated together with the rotor shaft 16. Further, the conductive ring 108 is connected to the housing and being static. By radial vibrations of the rotor shaft 16, an eddy current is induced into the conductive element which creates a magnetic force acting in the opposite direction of the vibration movement resulting in a restoring force to the rotor, thereby damping the radial vibrations of the rotor.

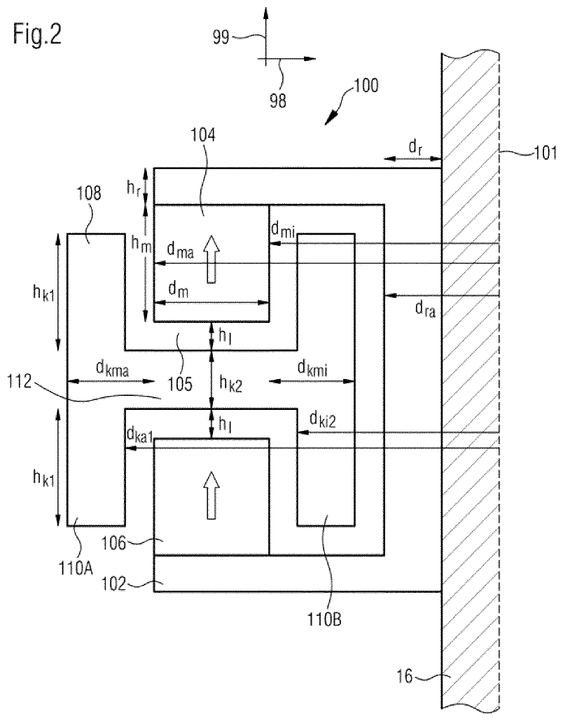

Referring now to FIG. 2 showing a detailed view of the configuration of the ECD being rotationally symmetric around axis 101. Same or similar elements are indicated by the same reference signs. Further, in the following and also the description of FIG. 1 reference to the axial direction 99 of the vacuum pump and the radial direction 98 is made as indicated in FIG. 2.

It has been shown to be advantageous by simulation and experiment to use certain dimensions to provide an efficient damping with minimum space requirements. Therein, in order to enhance the magnetic field at the position of the radial extending part 112 of the conductive ring 108 to create larger eddy currents, the first ring magnet 104 and the second ring magnet 106 should be as close as possible together, reducing the size h of the gap 105 and the axial width hₖ₂ of the radial extending part 112 of the conductive ring 108. However, when reducing the axial width hₖ₂ of the radial extending part 112 of the conductive ring 108, the cross-section of the conductor formed by the conductive ring 108 is reduced, thereby increasing the ohmic resistance leading to an attenuation of the eddy currents induced into the conductive ring 108. Thus, the axial extending part 110A is connected to the radial extending part 112 of the conductive ring 108 in order to increase the cross-section and reduce the ohmic resistance in order to efficiently generate eddy currents in the conductive ring 108 that create the magnetic force onto the first ring magnet 104 and the second ring magnet 106 in the exact opposite direction of the vibration movement, acting as a restoring force for the rotor shaft 16. As shown in FIG. 2, a second axial extending part 110B can be connected to the opposite end of the radial extending part 112 of the conductive ring 108 in order to further enhance the flow of the eddy currents within the conductive ring 108. Thus, the conductive ring 108 of FIG. 2 has a H-shaped cross-section.

Thus, it could be shown that a most efficient and compact ECD could be built with one or more of the following conditions (see FIG. 2):
For the conductive ring 108: 0<dₖₘₐ<dₘ and 0<dₖₘᵢ<dₘ;
Further, for the conductive ring 108: 0<hₖ₂<ₘ;
Shaping the conductive ring 108 so that the axial extending part 110A/110B radially surround the ring magnets at larger and/or smaller diameters, i.e. 0<hₖ₁<hₗ+hₘ;
For the first ring magnet 104: 3 mm<dₘ<10 mm;
For the second ring magnet 106: 3 mm<dₘ<10 mm;
For the gap between first ring magnet 104 and the radial extending part 112 of the conductive ring 108: 0.1 mm<hₗ<1 mm;
For the gap between second ring 106 magnet and the radial extending part 112 of the conductive ring 108: 0.1 mm<hₗ<1 mm;
For the gap between first ring magnet and/or second ring magnet and the first axial extending part 110A of the conductive ring 108: 0.1 mm<dₖₐ₁−dₘₐ<1 mm;
For the gap between first ring magnet and/or second ring magnet and the second axial extending part 110B of the conductive ring 108: 0.1 mm<dₘᵢ−dₖᵢ₂<1 mm.
For the yoke: 0<hᵣ<hₘ;
For the yoke: 0<dᵣ<hₘ; and
For the yoke: hₘ<dₘᵢ−dᵣₐ<5hₘ.

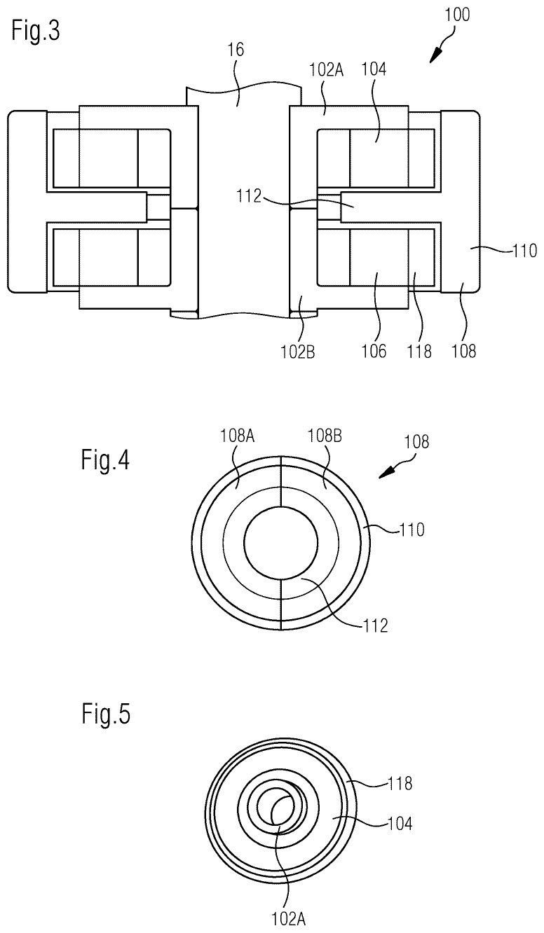

Referring to FIG. 3 showing an alternative embodiment of the eddy current damper, wherein the cross-section of the conductive ring 108 is T-shaped. Further, it is shown that the yoke 102 is separated in an axial direction into a first yoke part 102A and a second yoke part 102B for ease of assembly.

Referring to FIG. 4 showing the conductive ring 108 in a plain view, wherein the axial extending part 110 extends out of the paper level and the radial extending part 112 of the conductive ring extends in the paper level. Therein, the conductive ring 108 is built by two parts 108A and 108B separating the conductive ring along a circumferential direction. Thus, the conductive ring 108 can be easily assembled around the rotor shaft 16 is an interlocking manner with the first and second ring magnets 104, 106.

Referring to FIG. 5 showing the first ring magnet 104 including part of the yoke 102A, wherein the first ring magnet 104 is surrounded by a reinforcement element 118 in order to withstand the rotational forces during operation of the vacuum pump.

Thus, with the found configuration of the ECD, a compact and efficient ECD can be realized which can be implemented in different types of vacuum pumps. Although, the ECD according to the present invention is shown in a turbomolecular pump, other types of vacuum pumps and pump stages could also benefit from the ECD according to the present invention.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An eddy current damper for a vacuum pump comprising
a conductive ring connectable to a housing;
a magnetic element connectable to a rotor shaft to be rotated relative to the conductive ring;
wherein the conductive ring is made from a conductive material and comprises an axial extending part and a radial extending part and
wherein the magnetic element comprises at least one ring magnet wherein the radial extending part of the conductive ring is arranged axially next to the at least one ring magnet.

2. The eddy current damper according to claim 1, wherein the magnetic element comprises a second ring magnet arranged opposite to the first ring magnet relative to the conductive ring.

3. The eddy current damper according to claim 2, wherein the first ring magnet and the second ring magnet have the same orientation of magnetic poles.

4. The eddy current damper according to claim 2, wherein the second ring magnet is connectable to the housing or connectable to the rotor shaft.

5. The eddy current damper according to claim 2, wherein by the first ring magnet and the second ring magnet a radial extending gap is formed, wherein the radial extending part of the conductive ring is at least partially extending into the gap.

6. The eddy current damper according to claim 2, wherein a yoke is provided made from a magnetic material magnetically connecting the first ring magnet and the second ring magnet.

7. The eddy current damper according to claim 6, wherein the yoke comprises two radial extending parts each magnetically connected to the first and second ring magnets and an axial extending part connecting the two radial extending parts.

8. The eddy current damper according to claim 7, wherein the radial width of the axial extending part of the yoke is smaller than the axial width of the first and/or second ring magnets.

9. The eddy current damper according to claim 7, wherein the axial width of at least one of the two radial extending parts of the yoke is smaller than the axial width of the first and/or second ring magnet.

10. The eddy current damper according to claim 7, wherein the distance between the radial outermost surface of the axial extending part of the yoke to the first and/or second ring magnet is between one time to five times the axial width of the first and/or second ring magnet.

11. The eddy current damper according to claim 1, wherein the first and/or second ring magnet extends in the axial direction beyond the axial extending element of the conductive ring.

12. The eddy current damper according to claim 1, wherein the conductive ring comprises a second axial extending part arranged at the opposite end of the radial extending part opposite to the first axial extending part.

13. The eddy current damper according to claim 1, wherein the conductive ring is separated into at least two parts along a circumferential direction of the conductive ring.

14. The eddy current damper according to claim 1, wherein the conductive ring and the magnetic element are rotationally symmetrical.

15. The eddy current damper according to claim 1, wherein the distance between the outermost or innermost radial surface of the conductive ring and the respective outermost or innermost radial surface of the first and/or second ring magnet is smaller than the radial width of the first ring magnet and/or second ring magnet.

16. The eddy current damper according to claim 1, wherein the axial width of the radial extending part of the conductive ring is smaller than the axial width of the first and/or second ring magnet.

17. The eddy current damper according to claim 1, wherein the radial width of the first and/or second ring magnet is between 2 mm and 20 mm, preferably between 3 mm and 10 mm.

18. The eddy current damper according to claim 1, wherein the axial distance between the radial extending part of the conductive ring and the first and/or second ring magnet is between 0.05 mm and 2 mm, preferably between 0.1 mm and 1 mm.

19. The eddy current damper according to claim 1, wherein the radial distance between an inner surface of the axial extending part of the conductive ring and the first and/or second ring magnet is between 0.05 mm and 2 mm, preferably between 0.1 mm and 1 mm.

20. A vacuum pump comprising a housing, a rotor disposed in the housing and an eddy current damper according to claim 1, wherein the first ring magnet is connected to the rotor and the conductive ring is connected to the housing.
